(19) United States
(12) Patent Application Publication
(10) Pub. No.: US 2005/0258639 A1
(43) Pub. Date: Nov. 24, 2005

(54) Protection and nondestructive annotation of documents

(76) Inventor: Shelley T. O'Neill, Philadelphia, PA (US)

Correspondence Address: WILLIAM H. EILBERG, THREE BALA PLAZA, SUITE 501 WEST, BALA CYNWYD, PA, 19004, US

(21) Appl. No.: 10/848,934

(22) Filed: May 19, 2004

(51) Int. Cl. B42D 15/00

(52) U.S. Cl. 283/109

(57) ABSTRACT

A transparent sheet is laid over a document so as to protect the document, and to enable a user to annotate the document nondestructively. The transparent sheet is preferably affixed to the document by a repositionable adhesive. The transparent sheet could also be placed over a sign, or other surface, so as to create, annotate, or modify the sign. The transparent sheet may be obtained from a pad of such sheets, held together by adhesive. By writing or printing on the transparent sheet, and by superimposing the sheet over a document, a supervisor can communicating comments and/or corrections to the person who created the document, without mutilation of the document.

### BACKGROUND OF THE INVENTION

The present invention relates to the field of auditing and document management, and provides a method for the nondestructive annotation of documents.

There are many situations in which a document is generated by one person, and then reviewed or audited by another. In one example, chemists, research scientists, and laboratory technicians keep laboratory notebooks that are audited or checked for compliance with federal regulations. The auditor needs to communicate comments or corrections, without altering the original document. In another example, accountants and bookkeepers prepare spreadsheets, or other documents, which must then be cross-checked by others. Again, the person performing the review must be able to communicate changes, without altering the original work, so that the person preparing the document can make the changes in a proper manner.

In the prior art, such annotations or comments have typically been made with paper notes, including notes having a repositionable adhesive formed thereon. Such paper notes can become so numerous as to cause inconvenience. Moreover, paper notes can often become dislodged from the document and lost. They also do nothing to preserve the underlying document.

The present invention provides a method which allows an auditor to review a document, and indicate comments or changes, without altering the document, and while protecting the document from damage. The invention can be used not only in the fields mentioned above, but in any other situation in which it is necessary to annotate and/or preserve a document. The invention has further utility in making and/or altering signs or other handwritten or printed material.

### SUMMARY OF THE INVENTION

The present invention comprises a method for protecting and/or nondestructively annotating a document or sign.

The method of the present invention includes placing a sheet of transparent material, preferably flexible plastic, onto the document or sign, and writing or printing on the transparent sheet. The transparent sheet is preferably affixed to the document or sign by an adhesive, especially a repositionable adhesive. The information on the transparent sheet becomes superimposed with the information on the underlying document.

In one embodiment, a supervisor reviews a document, such as a laboratory notebook or accounting sheet, and communicates changes, comments, corrections, or other messages, to the person who prepared the document, by writing information onto the transparent sheet. In this way, the supervisor does not alter the underlying document, while still conveying the desired information.

In another embodiment, the transparent sheet is used to modify a sign containing verbal information. For example, the sign could describe an event held annually, and the date of the event could be provided on the transparent sheet. In this way, the sign can be used repeatedly, simply by providing a new transparent sheet.

The transparent sheet preferably has an adhesive disposed at least along one edge of the sheet, so that the transparent material may be conveniently adhered to the document or sign. The transparent sheet is preferably taken from a pad comprising a plurality of such sheets, held together by adhesive means.

By superimposing the transparent sheet onto the document or sign, one creates, in effect, an annotated or altered document or sign, even though the document or sign itself is not mutilated or destroyed. Superimposing the transparent plastic sheet onto the document or sign also serves to protect the underlying item, especially where the plastic sheet is of the same size as the document or sign.

The present invention therefore has the primary object of providing a method for nondestructive annotation of a document.

The invention has the further object of providing a method for protecting a document from damage.

The invention has the further object of providing a method for nondestructively modifying a sign.

The invention has the further object of providing a method of modifying and re-using a sign.

The invention has the further object of providing a convenient method by which a supervisor may comment on written or printed work performed by another, without using paper notes, and without mutilating the original work.

The invention has the further object of providing a pad of transparent sheets, held together adhesively, wherein each sheet can be used in the method described above.

The reader skilled in the art will recognize other objects and advantages of the present invention, from a reading of the following brief description of the drawings, the detailed description of the invention, and the appended claims.

### BRIEF DESCRIPTION OF THE DRAWINGS

FIG. 1 provides a plan view of a laboratory notebook, in which a transparent sheet bearing annotations overlays a page of the notebook, in accordance with the present invention.

FIG. 2 provides another view of the laboratory notebook of FIG. 1, but showing the transparent sheet being partially lifted away from the notebook.

FIG. 3 provides a plan view of an accounting document, covered with a transparent sheet bearing annotations, in accordance with another use of the present invention.

FIG. 4 provides a view similar to that of FIG. 3, but showing the transparent sheet being partially lifted from the document.

FIG. 5 provides a plan view illustrating another use of the present invention, wherein a transparent sheet has been placed over a sign, so as to provide additional information beyond what was originally included in the sign.

FIG. 6 provides a perspective view of a pad of transparent sheets, used in the present invention.

FIG. 7 provides another perspective view of the pad of FIG. 6, showing the top sheet partially peeled away, and also illustrating the adhesive formed on the top sheet.

### DETAILED DESCRIPTION OF THE INVENTION

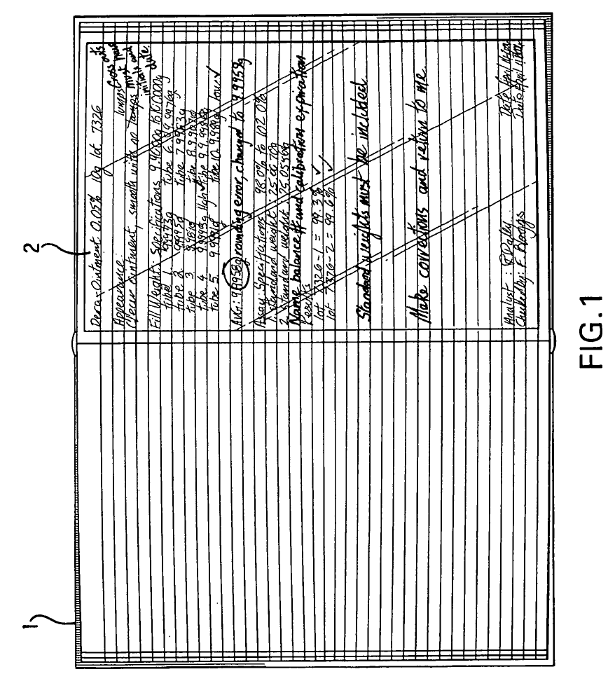

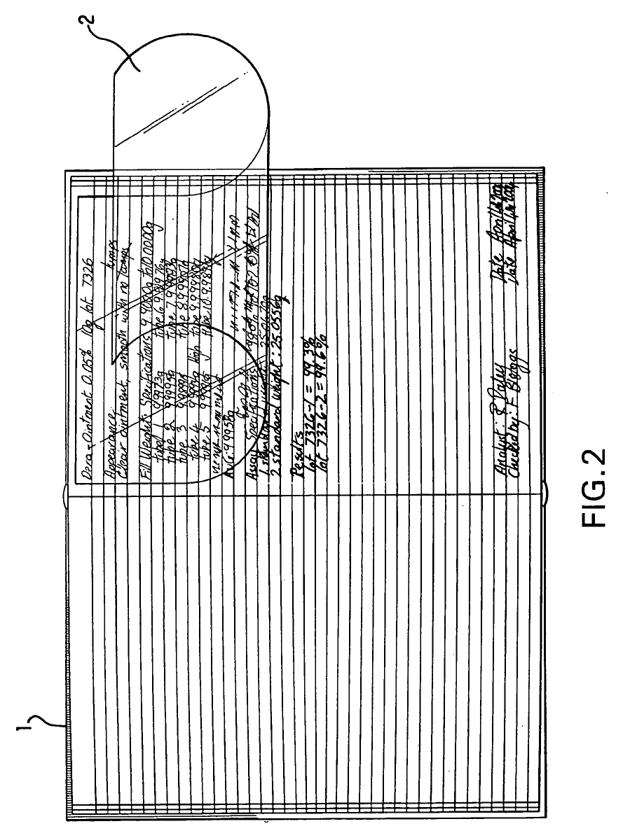

The present invention provides a method for non-destructive review and auditing of a document. A preferred embodiment of the invention is illustrated by FIGS. 1 and 2.

FIGS. 1 and 2 illustrate a page of a hypothetical laboratory notebook 1. A transparent sheet 2, preferably made of plastic, overlays the page of the notebook. In FIG. 2, the sheet 2 is shown partially lifted from the page.

The transparent sheet is preferably attached by an adhesive to the page of the notebook. Preferably, the adhesive is a repositionable adhesive, which could be the same as, or similar to, the repositionable adhesive used in the product sold under the trademark “Post-It”, by the Minnesota Mining and Manufacturing Company, or repositionable adhesives sold by other manufacturers. In the example shown, the adhesive is provided along one edge of the transparent sheet, so that the sheet will remain attached to the notebook even when it is partially lifted as shown in FIG. 2. The adhesive could be provided in other configurations, and not just along one edge of the transparent sheet.

In the example of FIGS. 1 and 2, the underlying laboratory notebook could have been prepared by a chemist or other scientist, who at some point submits the notebook to a supervisor or auditor for review. The transparent sheet 2 contains annotations made by the supervisor or auditor.

In the example shown, the supervisor has made the following comments and corrections. First, near the top of the page, the comment “Cross outs must have initials and date” tells the chemist to correct the manner in which an item was crossed out.

Next, the comment “rounding error, changed to 9.995 g”, accompanied by a circle around the erroneous number, tells the chemist how to correct the presentation of a calculated average weight, and highlights the erroneous number.

Next, the comment “name, balance # and calibration expiration” tells the chemist that the latter information must be included.

Next, the comment “standard weights must be included” tells the chemist to include standard weights against which each sample is measured.

Finally, the comment “make corrections and return to me” instructs the chemist to make the indicated corrections and return the notebook to the supervisor.

Note also that the transparent sheet contains various check marks, corresponding to specific numbers on the notebook, indicating that the supervisor has checked and approved these entries.

The use of the transparent sheet enables the supervisor to communicate various corrections, comments, instructions, and/or other messages, all without altering the original underlying document. The supervisor may cite mathematical or procedural errors, by circling the error and inserting a note explaining what is wrong. The supervisor may also include notes or instructions to the person who prepared the notebook. The supervisor may even include messages that do not directly relate to the subject matter of the document. All of these corrections, notes, instructions, and/or messages, are written only on the transparent sheet, and no alteration of the underlying text is made. The person preparing the notebook may then take appropriate corrective action, by removing the transparent sheet, and by making the necessary corrections in a proper and approved manner. The notebook can then be returned to the supervisor, either with or without the transparent sheet.

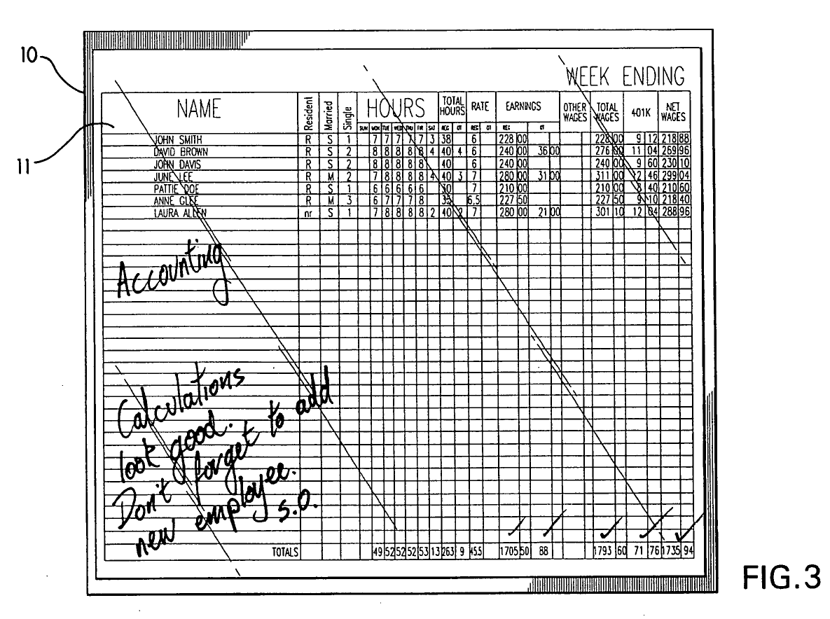

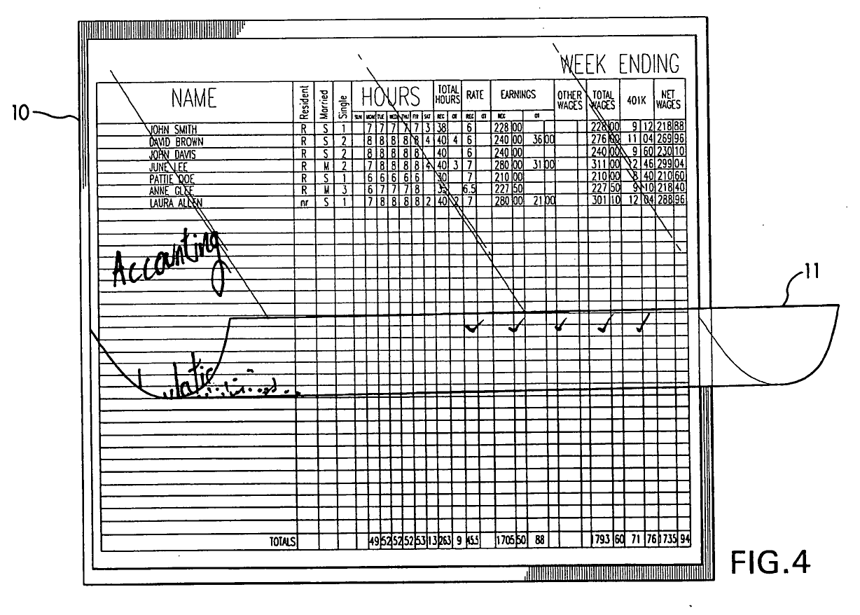

Another use of the present invention is illustrated in FIGS. 3 and 4. In this example, the underlying document is an accounting sheet which could have been prepared by an accountant or bookkeeper. The document is then submitted to an auditor. FIG. 3 shows the accounting sheet 10, together with transparent sheet 11 which overlays the sheet 10. The transparent sheet 11 is more clearly visible in FIG. 4, which shows the sheet 11 being partially lifted from the accounting sheet 10, while the transparent sheet is still adhesively attached to the accounting sheet. As in the previous example, the adhesive is provided along one edge of the transparent sheet, so that the transparent sheet can be lifted, as shown in FIG. 4, while still remaining adhesively attached to the underlying document, along one edge.

In the example of FIGS. 3 and 4, the accounting sheet comprises a tabular summary of the hours worked, wages, and deductions for a group of hypothetical employees. In the example given, the supervisor has approved the calculations, by placing check marks above some of the sums at the bottom of the sheet. Also, the supervisor has added the notation “Accounting”, indicating that the sheet has been reviewed by the Accounting Department.

The transparent sheet of FIGS. 3 and 4 also contains the comments “Calculations look good” and “Don't forget to add new employee”, and the initials “S.O.” The comments tell the bookkeeper that the calculations have been checked and approved, and remind the bookkeeper to add a new employee. The initials belong to the hypothetical auditor.

As in the first example, none of the comments or messages contained on the transparent sheet 11 makes any change to the underlying document. When the bookkeeper receives the accounting sheet with the transparent overlay, the bookkeeper can make whatever changes are necessary to the document, and can re-submit the document to the auditor, either with or without the transparent sheet attached.

In both of the above examples, the transparent sheet has served as a medium of communication, allowing a supervisor to transmit comments, corrections, instructions, or messages to the person who prepared the underlying document.

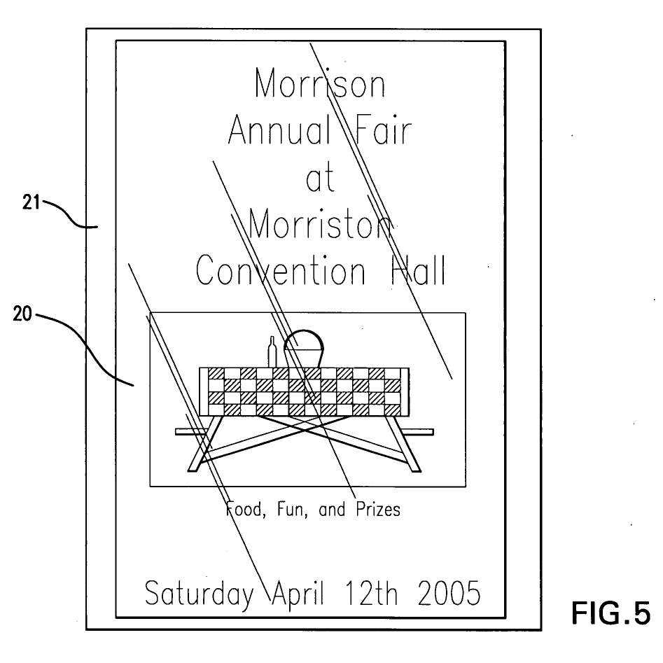

FIG. 5 provides another example of the use of the present invention. In FIG. 5, a sign 21 announces an annual fair. Because it is an annual fair, the sign 21 has been prepared without a date, and the date is supplied by attaching transparent sheet 20. In the example given, the wording “Saturday Apr. 12, 2005” is printed only on the transparent sheet, and the transparent sheet is then attached to the sign 21. The sign 21 is not mutilated, and can be used again in subsequent years, each time using a new transparent sheet, bearing a new date.

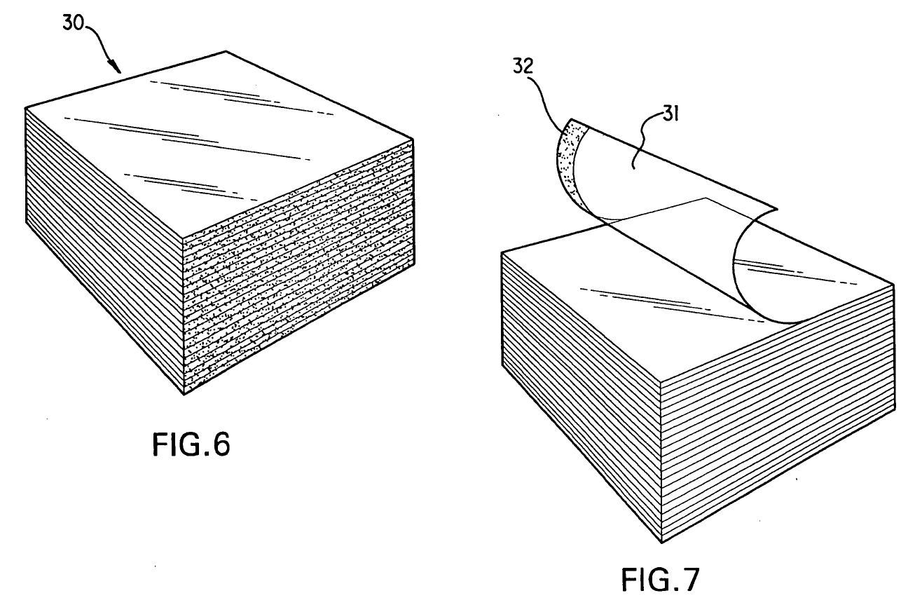

In all of the above examples, the present invention uses a sheet of transparent material which is placed over a document or sign. The transparent sheet can be advantageously provided in the form of pads, as illustrated in FIGS. 6 and 7. FIG. 6 shows pad 30 formed of a plurality of transparent sheets. The sheets are preferably formed of a flexible but sturdy plastic material. However, the invention is not limited by the specific material chosen. FIG. 8 shows the pad with the top sheet 31 partially peeled away. The sheets are provided with a strip of adhesive 32, preferably formed in a band disposed along an edge of the sheet, and preferably a repositionable adhesive as described above.

Thus, each transparent sheet of the pad 30 can be removed and immediately affixed to a document, sign, or surface, using the adhesive provided with each sheet. In general, the transparent sheet can be removed and replaced numerous times, as is known in the art. The sheets are preferably held together in the pad solely by the adhesive.

The sheets of pad 30 may be of virtually any size. The sheets could be relatively small, of the order of one or two inches per side, or they could be relatively large, similar in size to a standard sheet of 8×11 inch paper, or even much larger. In all cases, the principle of operation is the same.

Thus, in one form, the invention includes the method of communicating comments, corrections, or other messages, to the person who prepared an information-containing document, such as a laboratory notebook or an accounting sheet. In another form, the invention includes the method of effectively modifying a sign, without directly altering the sign, so that the sign can be used again, possibly with a different transparent overlay.

The transparent sheet, used in the present invention, not only facilitates communication as described above, but also protects the underlying document, especially when the transparent sheet is made of stiff plastic. In a preferred embodiment, the size of the transparent sheet is chosen to be approximately the same as that of the document, so that the sheet adequately protects the entire document. However, the invention could be practiced with a sheet that does not fully cover the document, in which case the protection would be only partial.

In the above examples, the transparent sheet of the present invention is used as a corrective device, enabling the user to correct a document manually. The user may indicate misspellings or document errors, or provide comments or explanations, or make inquiries of the person who created the document. All of the above annotations are made without mutilating the underlying document. The indicia on the transparent sheet are superimposed over the indicia found on the original document. In this way, one can avoid the use of numerous, and possibly voluminous, paper message notes, or adhesive notes affixed to a document. The use of the transparent sheets of the present invention can therefore streamline the operations of a business or other institution.

There are many other examples of the use of the present invention. For example, the invention can be used by museum curators who wish to provide annotations for historical documents, such as manuscripts or photographs, without altering or mutilating the documents. The protective function of the transparent sheets is especially important in this context.

The invention could also be used in scrapbooks and photograph albums, allowing the user to annotate various items without mutilating them, and also providing additional protection, by covering the items with plastic.

As shown in FIG. 5, the present invention can be used to modify a sign without destroying or mutilating the sign. The sign, onto which the transparent sheet is affixed, need not be a printed sign, but could instead be a non-verbal graphic. For example, one could provide a drawing of a computer and monitor, and provide a transparent sheet that covers the drawing, so that the words “Out of Order” appear over the monitor. Removal of the transparent sheet could then indicate that the computer is working.

In still another embodiment of the present invention, the surface onto which the transparent sheet is attached may not have any printed, written, or artistic material. One can simply apply a transparent sheet to a surface, and write on that sheet, thereby creating a sign. Or one could write, print, or draw on the transparent sheet, and then attach that sheet to an appropriate surface. For example, one could attach the transparent sheets to boxes used in moving and storage, and could write information onto the sheet, indicating the contents or location of the box. One could also form signs for virtually any other purpose, simply by writing the desired information onto a transparent sheet, and affixing the sheet to an appropriate surface. In all cases, it is preferred that the affixation be by repositionable adhesive, so that the sheet can be easily attached and easily removed.

The present invention has many further applications in schools. The transparent sheets could be used to make or alter posters, calendars, updates, and message boards. In each case, the transparent sheet could be used to alter the contents of an underlying sign or document, or it could comprise a document in itself.

In FIG. 7, the adhesive 32 is shown disposed along only one edge of the transparent sheet. The latter arrangement is useful in applications where one needs to be able to lift the transparent sheet from the document, without removing the sheet from the document. But the adhesive could be formed in other ways. It could be formed over a larger portion of the sheet, and it could be formed along more than one edge. It could even be disposed over an entire surface of the sheet. The latter arrangement would be preferred if the transparent sheet constitutes a sign in itself, and where one does not need access to the underlying document or surface. All of the above arrangements of the adhesive should be considered within the scope of the invention.

Although the use of adhesives is preferred, the transparent sheet could also be affixed to the document or surface by means other than an adhesive, such as by pins, clips, staples, or other means. Also, the adhesive used could be repositionable or conventional. A conventional, non-repositionable adhesive would be acceptable in applications where the transparent sheet is intended to remain permanently affixed to a document or surface.

The transparent sheet has been described as plastic. However, the invention should not be considered limited to any particular form of material. What is important is that the sheet be transparent, capable of being affixed to the desired document or surface, and capable of receiving written or printed annotations.

In the embodiments of the invention where a supervisor reviews and corrects a document prepared by another, it is necessary first to affix the transparent sheet to the document before writing on the transparent sheet, so that the annotations on the transparent sheet properly correlate with items on the underlying document. But it is also possible, in some embodiments, such as in modifying a sign, to write or print on the sheet before affixing it to a surface, as might be done in the example of FIG. 5.

In general, if a particular application requires exact and precise registration between the underlying document and the transparent sheet, it is usually preferable to create annotations on the transparent sheet after it has been placed over the document.

While the invention has been described with respect to certain embodiments, it will be understood that the invention can be modified further, as will be apparent to the reader skilled in the art. Such modifications should be considered within the spirit and scope of the following claims.

1. A method for communicating comments or corrections to a laboratory notebook, comprising:
a) placing a transparent sheet over a page of a laboratory notebook, the page containing written or printed information,
b) writing comments and/or corrections on the transparent sheet, and
c) returning the notebook, with the transparent sheet, to a person who prepared the notebook.

2. The method of claim 1, wherein step (a) comprises affixing the transparent sheet to the notebook by an adhesive.

3. The method of claim 1, further comprising removing the transparent sheet and making corrections in response to comments contained on the transparent sheet.

4. The method of claim 2, wherein the adhesive is selected to be a repositionable adhesive.

5. A method for communicating comments or corrections to a document containing written or printed information, comprising:
a) placing a transparent sheet over a document containing written or printed information,
b) writing comments and/or corrections on the transparent sheet, and
c) returning the document, with the transparent sheet, to a person who prepared the document.

6. The method of claim 5, wherein step (a) comprises affixing the transparent sheet to the document by an adhesive.

7. The method of claim 5, further comprising removing the transparent sheet and making corrections in response to comments contained on the transparent sheet.

8. The method of claim 6, wherein the adhesive is selected to be a repositionable adhesive.

9. A pad of transparent sheets, each sheet including an adhesive material disposed along at least part of a surface defined by the sheet, wherein each sheet in the pad is affixed to another sheet in the pad only by said adhesive material.

10. The pad of claim 9, wherein each sheet is made of plastic.

11. A method of protecting and nondestructively annotating a document, comprising:
a) affixing a transparent sheet of material to a document, the document containing information, and
b) writing comments and/or corrections, relating to the information in the document, on the transparent sheet,
wherein said comments and/or corrections become superimposed on the information in the document.

12. The method of claim 11, wherein step (a) is preceded by removing a transparent sheet from a pad of transparent sheets.

13. The method of claim 11, further comprising lifting the transparent sheet from the document so as to view at least part of the document in an unaltered form, while allowing the sheet to remain affixed to the document.

14. The method of claim 11, wherein step (a) is performed by adhesively attaching the transparent sheet to the document.

15. The method of claim 11, wherein step (a) is preceded by selecting a size of the sheet such that the sheet substantially covers the document.

16. A method of nondestructively modifying a sign containing verbal information, comprising:
a) affixing a transparent sheet of material to the sign, and
b) placing additional verbal information on the transparent sheet,
wherein the sign and the transparent sheet become superimposed, such that the verbal information on the transparent sheet modifies content of the sign without altering the sign.

17. The method of claim 16, wherein the transparent sheet is obtained by removing the transparent sheet from a pad of transparent sheets.

18. The method of claim 16, wherein step (a) is performed by adhesively attaching the transparent sheet to the surface.
